(19) United States
(12) Patent Application Publication
(10) Pub. No.: US 2025/0322567 A1
(43) Pub. Date: Oct. 16, 2025

(54) Cross-Regional and Cross-View Learning for Sparse-View Cone-Beam Computed Tomography Reconstruction

(71) Applicant: The Hong Kong University of Science and Technology, Hong Kong (CN)

(72) Inventors: Xiaomeng LI, Hong Kong (CN); Yiqun LIN, Hong Kong (CN)

(21) Appl. No.: 19/175,216

(22) Filed: Apr. 10, 2025

Related U.S. Application Data
(60) Provisional application No. 63/632,519, filed on Apr. 11, 2024.

(51) Int. Cl. G06T 11/00; G06T 17/00; G06V 10/771

(52) U.S. Cl. CPC G06T 11/006; G06T 17/00; G06V 10/771

(57) ABSTRACT

A cross-regional and cross-view learning (C²RV) framework is provided for sparse-view reconstruction in cone-beam computed tomography (CBCT) by advantageously leveraging cross-region and cross-view feature learning to enhance representation of a point in 3D space before estimating an attenuation coefficient of the point. Specifically, multi-scale 3D volumetric representations (MS-3DV) are first introduced, where features are obtained by back-projecting multi-view features at different scales to the 3D space. Explicit MS-3DV enable cross-regional learning in the 3D space, providing richer information that helps better identify different internal anatomy structures. Hence, features of the point can be queried in a hybrid way, i.e. multi-scale voxel-aligned features from MS-3DV and multi-view pixel-aligned features from projections. Instead of considering queried features equally, scale-view cross-attention (SVC-Att) is used to adaptively learn aggregation weights by self-attention and cross-attention. Finally, multi-scale and multi-view features are aggregated to estimate the attenuation coefficient.

### CROSS-REFERENCE TO RELATED APPLICATIONS

This application claims priority to, and the benefit of, U.S. Provisional Patent Application Ser. No. 63/632,519 filed Apr. 11, 2024, the disclosure of which is incorporated by reference herein in its entirety.

### ABBREVIATIONS

1D one-dimensional
2D two-dimensional
3D three-dimensional
ART algebraic reconstruction technique
ASD average surface distance
C²RV cross-regional and cross-view learning
C-Att cross-attention
CBCT cone-beam computed tomography
CNN convolutional neural network
CT computed tomography
DRR digitally reconstructed radiograph
DSO distance of source to origin
FBP filtered back projection
INR implicit neural representation
MLP multi-layer perceptron
MS-3DV multi-scale 3D volumetric representations
MSE mean square error
PSNR peak signal-to-noise ratio
S-Att self-attention
SMPL Skinned Multi-Person Linear Model
SSIM structural similarity
SVC-Att scale-view cross-attention

### TECHNICAL FIELD

This application generally relates to CBCT. In particular, this application relates to a sparse-view CBCT reconstruction framework, namely, a C²RV framework, by leveraging cross-regional and cross-view feature learning to enhance point-wise representation.

### BACKGROUND

CT has become an indispensable technique used for medical diagnostics, providing accurate and non-invasive visualization of internal anatomical structures. Compared with conventional CT (fan/parallel-beam), CBCT offers advantages, including faster acquisition and improved spatial resolution [28]. FIG. 1 depicts a schematic diagram of a typical CBCT imaging device 100 having a scanning source 110 for emitting cone-shaped X-ray beams 115 and a 2D array of detectors 120 for measuring power levels of received X-ray beams. The received X-ray beams form an image 140, also known as a projection, on the 2D array of detectors 120. Typically, hundreds of projections are required to produce a high-quality CT scan involving high radiation doses from X-rays. However, high radiation dose exposure to patients can be a concern in clinical practice, limiting its use in scenarios like interventional radiology. Hence, reducing the number of projections can be one of the ways to reduce the radiation doses, which is also known as sparse-view reconstruction.

Over the past decades, there have been many research works studying the sparse-view problem for conventional CT by formulating the reconstruction as a mapping from 1D projections to a 2D CT slice, where generation-based techniques [6, 7, 10, 13, 20, 20, 35, 37, 45] have been proposed to operate on the image or projection domains. However, measurements of cone-beam CT are 2D projections (as shown in FIG. 1), resulting in increased dimensionality when compared with conventional CT. It means that extending previous conventional CT reconstruction methods to CBCT encounters issues [18] such as a high computational cost.

Recently, INRs have been widely used in 3D reconstruction, including novel view synthesis and object reconstruction. To handle sparse-view or even single-view scenarios, geometric priors (e.g., surface points [40] and normals [41]) or parametric shape models [11, 38, 39, 46] (e.g., SMPL [19] and SMPL-X [24]) have been incorporated to improve the robustness and generalization ability. However, unlike visible light, X-rays have a higher frequency and pass through the surfaces of many materials. Hence, no depth or surface information can be measured in the projection. Additionally, it is difficult to build a CT-specific parametric model as the internal anatomies of the human body are more complicated than surface models.

Although INRs have been introduced to CBCT reconstruction in recent years, tens of views (i.e. 20-50) are still required for self-supervised NeRF-based methods [3, 31, 44] due to the lack of prior knowledge. On the other hand, current data-driven methods like DIF-Net [18] may suffer from poor performance when the anatomy has complicated structures for two possible reasons: (1) local features queried from projections can be difficult to identify different organs that have low contrast in the projection; and (2) projections of different views are processed equally, while some views indeed present more information of specific organs than other views. An example is shown in FIG. 2, which depicts a right-left view 260 and an anterior-posterior view 270 each showing constituent bones of a knee: a femur 211, a tibia 212, a patella 214 and a fibula 213. The right-left view 260 shows the patella 214 clearly, whereas the patella 214 overlaps the femur 211 in the anterior-posterior view 270.

There is a need in the art to have an improved technique for reconstructing CBCT images to address the limitations of previous works as mentioned above.

### SUMMARY

An aspect of the present disclosure is to provide a computer-implemented method for reconstructing a 3D CT volume from a plurality of projection views generated in CBCT imaging.

The method comprises the steps of: determining a plurality of points in the 3D CT volume such that the 3D CT volume is reconstructed via estimating an attenuation coefficient of an individual point; using a learnable encoder-decoder model to process an individual projection view to thereby generate a decoder-output feature map and an encoder-output feature map for the individual projection view, wherein the learnable encoder-decoder model is shared by the plurality of projection views in processing the individual projection view; using respective decoder-output feature maps generated for the plurality of projection views to query plural multi-view pixel-aligned features for the individual point; generating plural multi-view feature maps at different scales, the different scales consisting of a highest resolution and one or more reduced resolutions, wherein a first multi-view feature map generated at the highest resolution is obtained by grouping together respective encoder-output feature maps generated for the plurality of projection views, and wherein a corresponding multi-view feature map generated at an individual reduced resolution is obtained by down-sampling the first multi-view feature map; back-projecting the plural multi-view feature maps at the different scales to corresponding 3D spaces voxelized according to the different scales to thereby form plural multi-scale 3D volumetric representations, respectively; using the plural multi-scale 3D volumetric representations to query plural multi-scale voxel-aligned features for the individual point; and aggregating the plural multi-view pixel-aligned features and the plural multi-scale voxel-aligned features to estimate the attenuation coefficient of the individual point according to scale-view cross-attention for advantageously leveraging cross-region and cross-view feature learning to enhance representation of the individual point before the attenuation coefficient is estimated.

In certain embodiments, the plural multi-view pixel-aligned features for the individual point are obtained from the respective decoder-output feature maps by using the decoder-output feature map to query a view-specific pixel-aligned feature for the individual point under the individual projection view. Respective view-specific pixel-aligned features generated for the plurality of projection views are regarded as the plural multi-view pixel-aligned features for the individual point.

In certain embodiments, the view-specific pixel-aligned feature for the individual point under the individual projection view is obtained by interpolating the decoder-output feature map. In certain embodiments, k-linear interpolation, k an integer greater than unity, is used for interpolating the decoder-output feature map.

In certain embodiments, the step of using the plural multi-scale 3D volumetric representations to query the plural multi-scale voxel-aligned features for the individual point includes: interpolating the plural multi-scale 3D volumetric representations to yield plural scale-specific voxel-aligned features for the individual point, respectively; concatenating the plural scale-specific voxel-aligned features to yield concatenated voxel-aligned features for the individual point; and aggregating the concatenated voxel-aligned features to yield the plural multi-scale voxel-aligned features such that a channel size of the plural multi-scale voxel-aligned features is consistent with a channel size of the multi-view pixel-aligned features. In certain embodiments, k-linear interpolation, k an integer greater than unity, is used for interpolating each of the plural multi-scale 3D volumetric representations.

In aggregating the concatenated voxel-aligned features to yield the plural multi-scale voxel-aligned features, MLPs may be used to map the channel size of the plural multi-scale voxel-aligned features to be consistent with the channel size of the multi-view pixel-aligned features.

In certain embodiments, the step of aggregating the plural multi-view pixel-aligned features and the plural multi-scale voxel-aligned features to yield the attenuation coefficient of the individual point according to scale-view cross-attention includes: applying a self-attention to the plural multi-view pixel-aligned features for conducting cross-view attention across the plural multi-view pixel-aligned features, whereby plural attention-weighted pixel-aligned features are generated; applying a cross-attention between the plural multi-scale voxel-aligned features and the plural attention-weighted pixel-aligned features to thereby yield plural cross-region cross-view features for the individual point; and estimating the attenuation coefficient from the cross-region cross-view features.

In certain embodiments, the attenuation coefficient is estimated from the cross-region cross-view features by using a linear layer to process the cross-region cross-view features.

The method may further comprise the step of using a learnable aggregation-and-estimation model to aggregate the plural multi-view pixel-aligned features and the plural multi-scale voxel-aligned features to estimate the attenuation coefficient, wherein the learnable aggregation-and-estimation model comprises: a plurality of SVC-Att modules stacked together for applying the self-attention to the plural multi-view pixel-aligned features and applying the cross-attention between the plural multi-scale voxel-aligned features and the plural attention-weighted pixel-aligned features, wherein the plurality of SVC-Att modules outputs the plural cross-region cross-view features for the individual point; and a linear layer following the plurality of SVC-Att modules for estimating the attenuation coefficient from the cross-region cross-view features.

In certain embodiments, the learnable encoder-decoder model is implemented as a U-Net.

The method may further comprise training the learnable encoder-decoder model before using the learnable encoder-decoder model to process the individual projection view.

Similarly, the method may further comprise training the learnable aggregation-and-estimation model before aggregating the plural multi-view pixel-aligned features and the plural multi-scale voxel-aligned features to estimate the attenuation coefficient according to scale-view cross-attention.

Other aspects of the present disclosure are disclosed as illustrated by the embodiments hereinafter.

### BRIEF DESCRIPTION OF THE DRAWINGS

FIG. 1 depicts a schematic diagram of a typical CBCT imaging device, where cone-shaped X-ray beams are emitted from a scanning source and a 2D array of detectors measure power levels of received X-ray beams.

FIG. 2 depicts right-left view and anterior-posterior view of a knee formed with a femur, a tibia, a patella and a fibula, showing that the patella and femur overlap in the anterior-posterior view but not in the anterior-posterior view.

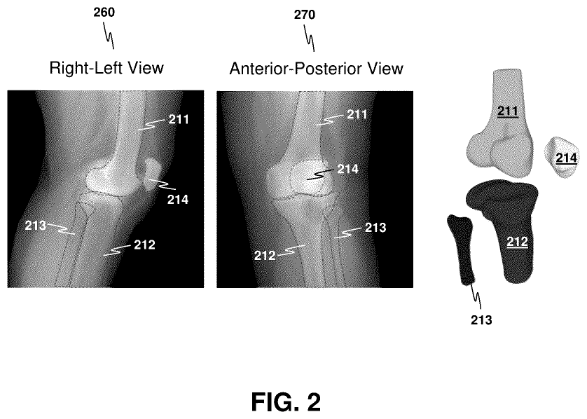

FIG. 3 is a conceptual diagram showing an overview of the disclosed sparse-view reconstruction framework, C²RV.

FIG. 4 provides a schematic diagram of a learnable aggregation-and-estimation model, which includes a SVC-Att module.

FIG. 5 provides visualization of 6-view reconstructed chest CT (from top to bottom: axial, coronal, and sagittal slice), with PSNR/SSIM (dB/×10⁻²) values presented in each visualized example.

FIG. 6 provides visualization of examples reconstructed from different numbers of projection views, i.e. 6, 8, and 10, with the highlighted regions zoomed in to show richer details in our reconstructed results than in other methods.

FIG. 7 provides visualization of lung segmentation on 6-view reconstructed chest CT.

FIG. 8 depicts a workflow showing exemplary steps of a computer-implemented method as disclosed herein for reconstructing a 3D CT volume from a plurality of projection views generated in CBCT imaging.

FIG. 9 depicts a workflow showing exemplary steps of the disclosed method regarding using plural multi-scale 3D volumetric representations to query plural multi-scale voxel-aligned features for an individual point.

FIG. 10 depicts a workflow showing exemplary steps of the disclosed method regarding aggregating plural multi-view pixel-aligned features and plural multi-scale voxel-aligned features to estimate an attenuation coefficient of the individual point according to scale-view cross-attention.

Skilled artisans will appreciate that elements in the figures are illustrated for simplicity and clarity and have not necessarily been depicted to scale.

### DETAILED DESCRIPTION

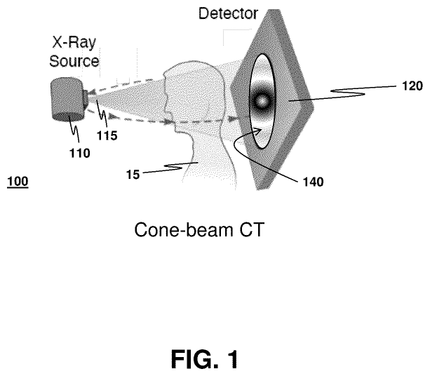

As used herein, “projection” in the context of CT imaging (including CBCT imaging) means an image formed on an X-ray detector by a resultant X-ray beam obtained from an original X-ray beam after the original X-ray beam is propagated through an object under imaging. The object is usually a human body. Herein in the specification and appended claims, “projection” and “projection view” in the context of CT imaging are used interchangeably. Take the CBCT imaging device 100 of FIG. 1 as an example for illustration. The 2D image 140 formed on the 2D array of detectors 120 is created by the cone-shaped X-ray beams 115 after the X-ray beams 115 pass through a human object 15. The 2D image 140 is a projection or a projection view.

To address the limitations of previous works, the present disclosure discloses a novel sparse-view CBCT reconstruction framework, referred to as C²RV, by leveraging cross-regional and cross-view feature learning to enhance point-wise representation. After the C²RV framework is detailed, embodiments of the present disclosure will be elaborated based on the disclosed details, examples, applications, etc. of the framework.

### 1. Overview of C²RV Framework

To be more specific in illustrating the C²RV framework, the present disclosure first introduces MS-3DV, where features are obtained by back-projecting multi-view features at different scales to the 3D space. Explicit MS-3DV enables cross-regional learning in 3D space, providing richer information that helps better identify different organs. Hence, the feature of a point can be queried in a hybrid way, i.e. multi-scale voxel-aligned features from MS-3DV and multi-view pixel-aligned features from projections. Instead of considering queried features equally, SVC-Att is then proposed to adaptively learn aggregation weights by self-attention and cross-attention. Finally, multi-scale and multi-view features are aggregated to estimate the attenuation coefficient. C²RV is then evaluated quantitatively and qualitatively on two CT datasets (i.e. chest and knee). Extensive experiments demonstrate that the proposed C²RV consistently outperforms previous state-of-the-art methods by a considerable margin under different experimental settings.

### 2. Related Works Useful for Developing C²RV Framework

Before the C²RV framework is explained, related works useful for developing C²RV are first mentioned.

In computer vision, especially 3D vision, the reconstruction problem has gained significant attention in recent years. In what follows, we mainly review related work of sparse-view reconstruction on traditional parallel/fan-beam CT, cone-beam CT, and general 3D.

### 2.1. Sparse-View CT Reconstruction

Traditional parallel/fan-beam CT reconstruction can be regarded as reconstructing a 2D CT slice from 1D projections. Existing learning-based methods mainly include image-domain, projection-domain, and dual-domain methods. Specifically, image-domain methods [6, 10, 13, 20, 35, 45] apply FBP to reconstruct a coarse CT slice with streak artifacts and utilize CNNs, such as U-Net [25] and DenseNet [9], to denoise and refine details. When extending these methods to CBCT reconstruction, the network should be modified to 3D CNNs, resulting in a substantial increase in computational cost. Another way is to adopt these methods for slice-wise (2D) denoising [15], while the 3D spatial consistency cannot be guaranteed.

Projection-domain methods directly operate on sparse-view 1D projections by mapping the projections to the CT slice [7] or recovering the full-view projections [37]. Additionally, Song et al. [32] utilize score-based generative models and propose a sampling method to reconstruct an image consistent with both the measurement process and the observed measurements (i.e. projections). Chung et al. [2] further incorporate 2D diffusion models into iterative reconstruction. Dual-domain methods operate on both projection and image domains by combining the denoising processes of two domains [17, 20] or modeling dual-domain consistency [34]. However, projection-based operations cannot be extended to CBCT reconstruction as the measurement processes (cone-beam vs parallel/fan-beam) are different.

### 2.2. Sparse-View CBCT Reconstruction

Different from traditional parallel/fan-beam CT, the measurement of cone-beam CT is a 2D projection, which means the reconstruction should be formulated as reconstructing a 3D CT volume from multiple 2D projections. Conventional filtered back-projection (FDK [4]) and ART-based iterative methods [1, 5, 22] often suffer from heavy streaking artifacts and poor image quality when the number of projections is dramatically decreased. Recently, learning-based approaches are proposed for single/orthogonal-view CBCT reconstruction [12, 14, 30, 42], while these methods are specially designed for single/orthogonal-view reconstruction [12, 14, 42] or patient-specific data [30], making them difficult to extend to general sparse-view reconstruction.

On the other hand, implicit neural representations [21, 26] have been introduced to represent CBCT as an attenuation [3, 44] or intensity [18] field. Self-supervised methods, including NAF [44] and NeRP [31], simulate the measurement process and minimize the error between real and synthesized projections. However, these methods require a long time for per-sample optimization and are only suitable for the reconstruction from tens of views (i.e. 20-50) due to the lack of prior knowledge. DIF-Net [18], as a data-driven method, formulates the problem as learning a mapping from sparse projections to the intensity field. Nevertheless, DIF-Net regards different projections equally, and only local semantic features are queried for each sampled point, leading to limited reconstruction quality when processing anatomies with complicated structures (e.g., chest).

### 2.3. Sparse-View 3D Reconstruction

In 3D computer vision, implicit representations have been widely used in novel-view synthesis [21, 40, 41, 43] and object reconstruction [11, 23, 27, 38, 39, 46]. For novel view synthesis, to extend NeRF [21] to sparse-view scenarios, geometric priors like surface points [40] and normals [41] are incorporated to improve the generalization ability and efficiency. For object reconstruction, particularly digital human reconstruction, previous works [11, 38, 39, 46] leverage explicit parametric SMPL(-X) [19, 24] models to constrain surface reconstruction and improve the robustness. However, there is no available depth or surface information in the attenuation fields of CBCT since X-rays penetrate right through many common materials, such as flesh. SMPL(-X) are 3D parametric shape models specially designed for the surface of the human body, while the internal anatomy structures are too complicated to design a CT-specific parametric model. Therefore, parametric shape models cannot be used in sparse-view CBCT reconstruction. Furthermore, cross-view relationships are rarely considered in surface-based reconstruction since one or two views are more practical and often sufficient to learn the sparse field with the above-mentioned priors.

### 3. Methodology for Developing C²RV

The problem formulation of sparse-view CBCT reconstruction and the baseline DIF-Net proposed in [18] are first revisited. C²RV, consisting of MS-3DV and the SVC-Att for cross-regional and cross-view learning, is then formally introduced.

### 3.1. DIF-Net [18] Revisited

We follow previous works [18, 44] to formulate the CT image as a continuous implicit function g: [symbol] → [symbol] , which defines the attenuation coefficient (same as “intensity” in [18]) v∈ [symbol] of a point p∈ [symbol] in the 3D space, i.e. v=g(p). Hence, given N-view projections J={I₁, . . . , I_{N}}⊂ [symbol] (W and H are width and height, respectively) with known scanning parameters (e.g., viewing angles, distance of source to origin) during the measurement process, the reconstruction problem is formulated as a conditioned implicit function [symbol] (⋅) such that v= [symbol] ( [symbol] ,p).

In practice, a 2D encoder-decoder (shared across different views) is used to extract multi-view feature maps [symbol] ={ [symbol] ₁, . . . , [symbol] _{N}}⊂ [symbol] from N-view projections [symbol] , where C is the output channel size of the decoder. For the ith view, denote the projection function as πᵢ: [symbol] → [symbol] , which maps a 3D point p to the 2D plane where detectors are located such that pᵢ′=πᵢ(p). Then, we define the view-specific pixel-aligned features of p in ith view as

$${ℱ}_{i} ( p ) = Interp ( {ℱ}_{i} , {π}_{i} ( p ) ) = Interp ( {ℱ}_{i} , {p}^{′} ) \qquad ( 1 )$$

where Interp: ( [symbol] , [symbol] )→ [symbol] is k-linear interpolation. Particularly, k=2 and Interp(⋅) is bilinear interpolation in the above equation.

Denoting multi-view pixel-aligned features of p as [symbol] (p)={ [symbol] ₁(p), . . . , [symbol] _{N}(p)}⊂ [symbol] , the attenuation coefficient of p is given by

$$v = g ( 𝒥 , p ) = σ ( ℱ ( p ) ) , \qquad ( 2 )$$

where σ(⋅) is the aggregation function implemented with MLPs (or Max-Pooling+MLPs) in DIF-Net [18]. Although the above formulation and implementation enable efficient training for high-resolution sparse-view reconstruction, only local pixel-aligned features queried from projections are considered and different views are processed equally, leading to poor performance on complicated anatomies; see analysis above and results in Table 1. To this end, we propose C²RV as follows.

### 3.2. C²RV Framework

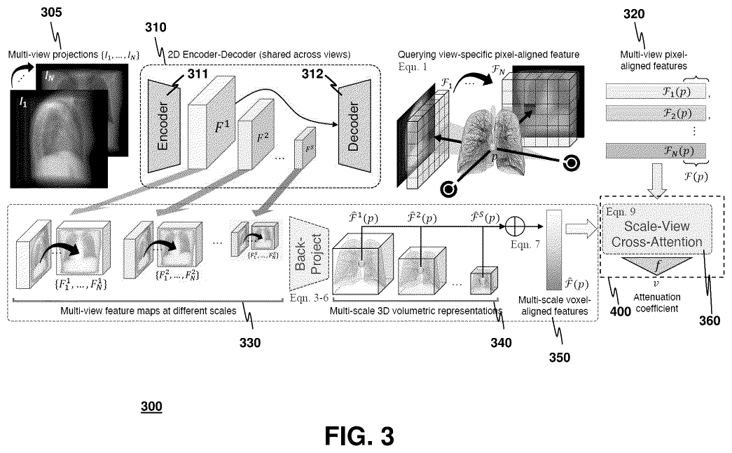

A C²RV framework is developed based on DIF-Net [18] to address the above-mentioned limitations. An overview of the C²RV framework 300 is shown in FIG. 3. Given multi-view projections 305, a 2D encoder-decoder 310 is applied to extract a view-wise feature map [symbol] ᵢ for querying the pixel-aligned feature [symbol] ᵢ(p). Additionally, the output feature map F¹ of the encoder 311 is down-sampled to obtain a multi-scale set of multi-view feature maps 330. At each scale s, multi-view features are back-projected to the 3D space and gathered to form the 3D volumetric representation [symbol] for querying the voxel-aligned feature [symbol] (p). Finally, multi-scale voxel-aligned features 350 and multi-view pixel-aligned features 320 are adaptively aggregated via scale-view cross-attention 360 to estimate the attenuation coefficient 390.

Low-Resolution 3D Volumetric Representation. A 3D volumetric space [symbol] ∈ [symbol] ^{×(r×r×r)} is defined by voxelizing the 3D space with a low resolution r≤16. Let [symbol] ∈ [symbol] be the intermediate feature map of the encoder-decoder given the projection of ith view. The volumetric feature space \hat{F}∈ [symbol] defined over [symbol] is produced by back-projecting multi-view feature maps into [symbol] , i.e.

$$\hat{F} = Back\_Project ( \{ {F}_{1} , … , {F}_{N} \} , 𝒮 ) \qquad ( 3 )$$

where the feature of a voxel q in [symbol] is

$$\hat{F} ( q ) = φ ( \{ {F}_{1} ( q ) , … , {F}_{N} ( q ) \} ) , \qquad ( 4 )$$

in which

$${F}_{i} ( q ) = Interp ( {F}_{i} , {π}_{i} ( q ) ) ,$$

and φ(⋅) is the aggregation function, implemented with Max-Pooling in practice. Therefore, 3D convolutional layers (denoted as ϕ) can be followed for efficient cross-regional feature learning, i.e.

$$\hat{ℱ} ( q ) = ϕ ( \hat{F} ) . \qquad ( 5 )$$

MS-3DV. To further improve the robustness of reconstructing different anatomical structures, we propose to leverage multiscale 3D volumetric representations. To be specific, given the projection of ith view, denote the output feature map of the encoder as Fᵢ¹, then a sequence of downsampling operators ρ are applied to produce multi-scale feature maps {Fᵢ¹, . . . , Fᵢ^{s}}, where Fᵢ^{s}=ρₛ₋₁(Fᵢ^{s-1}) for s∈{2, . . . , S}, and S is the total number of scales. Then, we define multi-scale 3D voxelized space { [symbol] ¹, . . . , [symbol] ^{S}} with different resolutions {r¹, . . . , r^{S}}, and back-project (EQNS. 3 and 5) multi-view feature maps of each scale to obtain MS-3DV { [symbol] , . . . , [symbol] }, where

$${\hat{ℱ}}^{s} = {ϕ}^{s} ( Back\_Project ( \{ {F}_{1}^{s} , … , {F}_{N}^{s} \} , {𝒮}^{s} ) ) \qquad ( 6 )$$

for s∈{1, . . . , S}. Hence, in addition to multi-view pixel-aligned features directly queried from view-specific feature maps, we incorporate multi-scale voxel-aligned features for the point p into the estimation of the attenuation coefficient, as given by

$$\hat{ℱ} ( p ) = MLPs ( Concat [ {\hat{ℱ}}^{1} ( p ) , … , {\hat{ℱ}}^{s} ( p ) ] ) , \qquad ( 7 )$$

where [symbol] (p)=Interp( [symbol] ,p), Concat[.] indicates concatenation, and MLPs map the channel size of concatenated voxel-aligned features to be consistent with pixel-aligned features (EQN. 1), i.e. C.

SVC-Att. We first recall the definition of C-Att [33] given the reference features Fᵣ∈ [symbol] and source features Fₛ∈ [symbol] .

$${C}_{Att ( {F}_{r} , {F}_{s} )} = soft max ( \frac{{QK}^{T}}{\sqrt{{C}_{d}}} ) V , \qquad ( 8 )$$

where Q=FᵣM_{q}, K=FₛMₖ, V=FₛMᵥ, in which M_{q}∈ [symbol] and Mₖ, Mᵥ∈ [symbol] . S-Att can be regarded as a special case of cross-attention where we let Fₛ=Fᵣ.

For a point p, let [symbol] (p)={ [symbol] (p), . . . , [symbol] (p)}⊂ [symbol] denote multi-view pixel-aligned features queried from projections (EQN. 1), and [symbol] (p)∈ [symbol] indicate the multi-scale voxel-aligned features queried from MS-3DV (EQN. 7). A SVC-Att module is proposed to adaptively aggregate the above features.

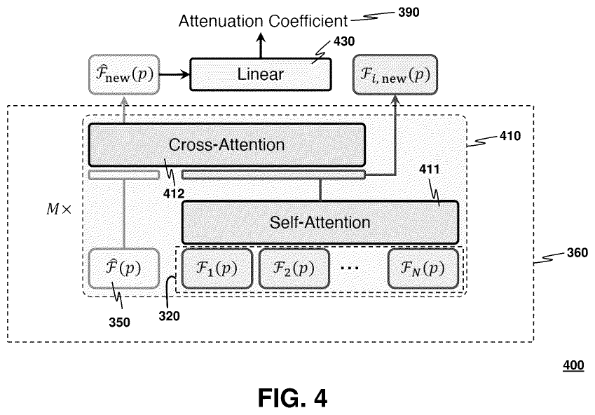

FIG. 4 provides a schematic diagram of a SVC-Att module 410 for realizing the scale-view cross-attention 360, and a learnable aggregation-and-estimation model 400 for performing aggregation and estimating the attenuation coefficient 390. In the SVC-Att module 410, self-attention 411 is first applied to the multi-view features 320, and cross-attention 412 is followed to conduct attention between multi-scale features 350 and multi-view features 320. As shown in FIG. 4, M SVC-Att modules 410 are stacked and finally followed by a linear layer 430 to estimate the attenuation coefficient 390. The linear layer 430 is also known as a fully-connected layer. Note that the learnable aggregation-and-estimation model 400 includes the M SVC-Att modules 410, and the linear layer 430.

In practical implementation, a self-attention module 411 is first applied to conduct cross-view attention on the multi-view features [symbol] (p) 320. Then, a cross-attention module 412 takes the multi-scale features 350 as the reference and the output of the self-attention module 411 as the source to conduct attention between the multi-scale and multi-view features 350, 320. To formulate, we have that

$${\hat{ℱ}}_{new} ( p ) = SVC\_Att ( \hat{ℱ} ( p ) , ℱ ( p ) ) = C\_Att ( \hat{ℱ} ( p ) , {ℱ}_{new} ( p ) ) , \qquad ( 9 )$$

where [symbol] (p)=S_Att( [symbol] (p)).

In practice, the M SVC-Att modules 410 are stacked and the linear layer 430 is followed to estimate the attenuation coefficient 390.

### 3.3. Network Training

We follow [18] to train the reconstruction network on a CT dataset, where the projections are simulated from the CT by DRRs. Specifically, we denote the volumetric CT as I_{ct}∈ [symbol] and the projections as [symbol] . Then, the ground-truth attenuation field defined over the continuous 3D space [symbol] is

$$𝒱 \{ v ( p ) = Interp ( {I}_{ct} , p ) \vert ∀ p ∈ 𝒫 \} , \qquad ( 10 )$$

where Interp(⋅) is the interpolation operator (EQN. 1). The estimated attenuation field by C²RV is given as

$$𝒱 = \{ \hat{v} ( p ) = g ( 𝒥 , p ) \vert ∀ p ∈ 𝒫 \} . \qquad ( 11 )$$

Hence, the MSE as the objective function is used to compute point-wise estimation error, and is given by

$${ℒ}_{MSE} ( 𝒱 , \hat{𝒱} ) = \frac{1}{\vert 𝒫 \vert} {\sum }_{p ∈ 𝒫} {( v ( p ) - \hat{v} ( p ) )}^{2} . \qquad ( 12 )$$

During each training iteration, we randomly sample 10,000 points from [symbol] for loss calculation (EQN. 12) to reduce the memory requirements for efficient network optimization. During the inference, the 3D space is voxelized with a specified resolution (e.g., 256³), where the attenuation coefficient of a voxel is defined as the estimated attenuation coefficient of its centroid point by C²RV. It means that the resolution can be chosen based on the desired tradeoff between image quality and reconstruction speed.

Implementation. In practice, we empirically choose S=3, r¹=16, and r^{s}=r^{s-1}/2 for s≥2. We follow [18] to use U-Net [25] with C=128 output feature channels as the 2D encoder-decoder, where the size of encoder output F¹ is

$$\frac{W}{16} \times \frac{H}{16} .$$

The function ϕ(⋅) in EQN. 5 is implemented with 3-layer 3D residual convolution that maps the channel size of \hat{F} to C. For the aggregation method, M=3 SVC-Att modules are stacked, and attention modules are implemented as multi-head attention with 8 heads. During training, the learnable parameters of C²RV are optimized using stochastic gradient descent with a momentum of 0.98 and an initial learning rate of 0.01. We train C²RV with 400 epochs and a batch size of 4. The learning rate is decreased by a factor of (10⁻³)^{1/400} per epoch.

### 4. Experiments

To validate the effectiveness of our proposed C²RV, we conduct experiments on two CT datasets with different anatomies, including chest and knee. In addition to quantitative and qualitative evaluation, automatic segmentation is applied to sparse-view reconstruction results, showing the practical potential of reconstructed CT by C²RV in downstream applications.

### 4.1. Experimental Setting

Dataset. Experiments are conducted on two CT datasets, including a public chest CT dataset (LUNA16 [29]) and a private knee CBCT dataset collected by Lin et al. [18]. Specifically, LUNA16 [29] is composed of 888 chest CT scans with resolution ranging from 145×145×108 to 375×375×509 mm³, split into 738 for training, 50 for validation, and 100 for testing; the knee dataset [18] contains 614 knee CBCT scans with resolutions ranging from 236×236×167 to 500×500×416 mm³, split into 464 for training, 50 for validation, and 100 for testing. We follow the data preprocessing of [18] to resample and crop (or pad) each CT to have isotropic spacing (i.e. 1.6 mm for chest and 0.8 mm for knee) and size of 256³. Multi-view 2D projections are simulated by DRRs with a resolution of 256², and the viewing angles are uniformly selected in the range of 180° (half rotation).

Evaluation Metrics. Following previous works [18, 31, 44], two quantitative metrics, including PSNR and SSIM [36], are used to evaluate the reconstruction performance, where higher values indicate superior image quality.

### 4.2. Results

Quantitative Evaluation. We compare our C2RV with self-supervised methods, including FDK [4], SART [1], NAF [44], and NeRP [31], without requiring additional training data. We also compare data-driven approaches, including 2D denoising-based (i.e. FBPConvNet [13], FreeSeed [20], and BBDM [16]) and implicit neural representation (INR)-based (i.e. PixelNeRF [43] and DIFNet [18]) methods. We conduct experiments with different numbers of projection views (i.e. 6-10) and the reconstruction resolution is 256³. The results are shown in Table 1, which compares performance results of different methods on two CT datasets, one for the chest and another for the knee, under various numbers of projection views. The resolution of the reconstructed CT is 256³. The reconstruction results are evaluated in term of PSNR (dB) and SSIM (×10⁻²), where a higher PSNR/SSIM value indicates a better performance. Although DIF-Net [18] can achieve satisfactory performance on knee CT, the performance drops dramatically when adapting to more complicated anatomical structures (e.g., chest), while our C²RV consistently performs well on different datasets. Additionally, when reconstructing from 6, 8, and 10 views, our C²RV outperforms previous state-of-the-art techniques by remarkable margins, i.e. 3.6/8.4, 3.1/8.4, and 3.5/7.9 PSNR/SSIM (dB/×10⁻²) on chest CT; and 2.6/4.5, 2.4/4.2, and 2.2/3.0 on knee CT. More importantly, even with only 6 views, C²RV can reconstruct CT of better quality than other methods with 4 more views (i.e. 10 views).

TABLE 1
Comparison of different methods on two CT datasets (i.e. chest and knee) with various numbers
of projection views.
(a) LUNA16 [29] (Chest CT)

| Method | Type | 6-view case | 8-view case | 10-view case |
|---|---|---|---|---|
| FDK [4] | Self-supervised | 15.34 \| 35.78 | 16.58 \| 37.89 | 17.40 \| 39.85 |
| SART [1] | | 19.70 \| 64.36 | 20.06 \| 67.80 | 20.23 \| 70.23 |
| NAF [44] | | 18.76 \| 54.16 | 20.51 \| 60.84 | 22.17 \| 62.22 |
| NeRP [31] | | 23.55 \| 74.46 | 25.83 \| 80.67 | 26.12 \| 81.30 |
| FBPConvNet [13] | Data-Driven | 24.38 \| 77.57 | 24.87 \| 78.86 | 25.90 \| 80.03 |
| FreeSeed [20] | Denoising | 25.59 \| 77.36 | 26.86 \| 78.92 | 27.23 \| 79.25 |
| BBDM [16] | | 24.78 \| 77.03 | 25.81 \| 78.06 | 26.35 \| 79.38 |
| PixelNeRF [43] | Data-Driven: INR- | 24.66 \| 78.68 | 25.04 \| 80.57 | 25.39 \| 82.13 |
| DIF-Net [18] | based | 25.55 \| 84.40 | 26.09 \| 85.07 | 26.67 \| 86.09 |
| C²RV | | 29.23 \| 92.78 | 29.95 \| 93.49 | 30.70 \| 94.03 |

(b) Lin et al. [18] (Knee CBCT)

| Method | Type | 6-view case | 8-view case | 10-view case |
|---|---|---|---|---|
| FDK [4] | Self-supervised | 17.71 \| 37.49 | 19.23 \| 40.51 | 20.50 \| 43.64 |
| SART [1] | | 24.73 \| 80.71 | 25.81 \| 84.08 | 26.72 \| 86.15 |
| NAF [44] | | 20.11 \| 58.43 | 22.42 \| 67.19 | 24.26 \| 75.02 |
| NeRP [31] | | 24.24 \| 70.05 | 25.55 \| 74.68 | 26.33 \| 79.81 |
| FBPConvNet [13] | Data-Driven | 25.10 \| 83.35 | 25.93 \| 83.47 | 26.74 \| 84.46 |
| FreeSeed [20] | Denoising | 26.74 \| 84.19 | 27.88 \| 85.62 | 28.77 \| 87.04 |
| BBDM [16] | | 26.58 \| 84.33 | 28.01 \| 85.46 | 28.90 \| 87.25 |
| PixelNeRF [43] | Data-Driven: INR- | 26.10 \| 87.69 | 26.84 \| 88.75 | 27.36 \| 89.58 |
| DIF-Net [18] | based | 27.12 \| 89.12 | 28.31 \| 90.24 | 29.33 \| 92.06 |
| C²RV | | 29.73 \| 93.64 | 30.68 \| 94.42 | 31.55 \| 95.01 |

The best values are bolded and the second-best values are underlined.

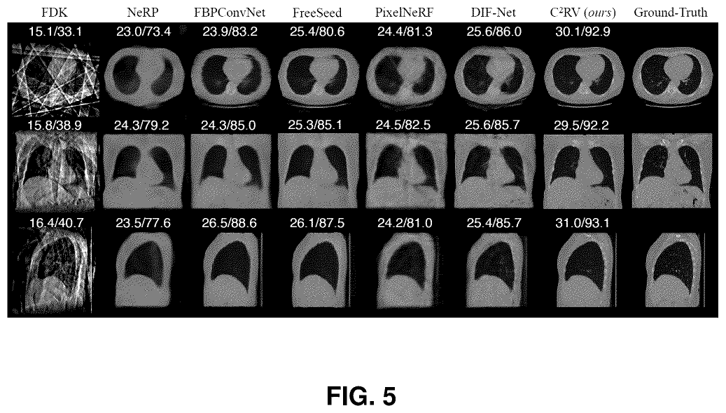

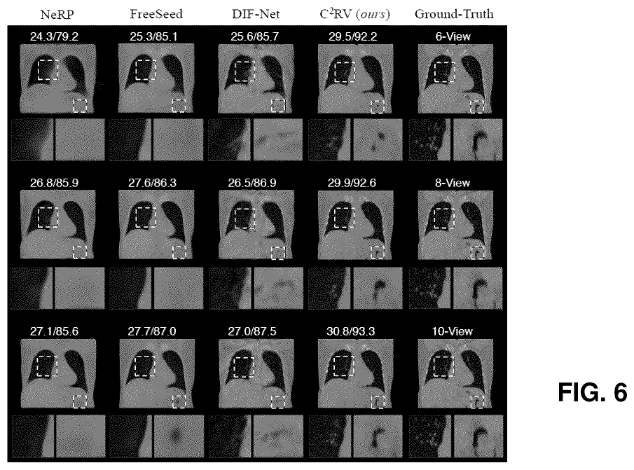

Visual Comparison. Examples of 6-view reconstruction for chest CT (from top to bottom: axial, coronal, and sagittal slice), with PSNR/SSIM (dB/×10⁻²) values presented above in each example, are visualized in FIG. 5 for qualitative comparison. Due to the lack of sufficient projection views, reconstruction results of FDK [4] are full of streaking artifacts, and NeRP [31] can only reconstruct satisfactory contours of the body and lung. For FBPConvNet [13] and FreeSeed [20], jitters appear near the boundary of the body and lung since they are 2D methods that reconstruct CT slice by slice. For Pixel-NeRF [43] and DIF-Net [18], although the details are reconstructed better than others, there are still a few streaking artifacts and unclear contours. The reconstructed results of C²RV have clearer shape contours, better internal details, and almost no streaking artifacts. Furthermore, FIG. 6 provides visualization of examples reconstructed from different numbers of projection views, i.e. 6, 8, and 10, demonstrating a consistent conclusion with the above. The highlighted regions are zoomed in, showing richer details in our reconstructed results than in other methods.

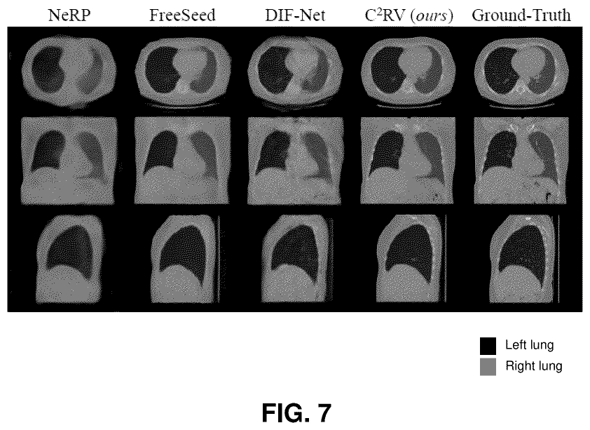

Downstream Evaluation. In addition to quantitative and qualitative evaluation, we validate the reconstructed CT on the downstream task, i.e. segmentation. Specifically, we utilize LungMask toolkit [8] to conduct left/right-lung segmentation on CT reconstructed by different methods. The segmentation results are shown in Table 2 and FIG. 7, where FIG. 7 provides visualization of lung segmentation on 6-view reconstructed chest CT. Compared with other methods, the segmentation masks on the reconstructed CT of C²RV are more consistent with the segmentation on the ground-truth CT. It means that our proposed C²RV has a potential to reconstruct high-quality CT that can be further applied in downstream scenarios.

TABLE 2
Lung segmentation of 6-view reconstructed chest CT. Dice coefficient
(%, higher is better) and average surface distance (ASD,
mm, lower is better) are evaluated. The best values are bolded
and the second-best values are underlined.

| | Recon. | | Left Lung | | Right Lung | |
|---|---|---|---|---|---|---|
| Method | PSNR | SSIM | Dice | ASD ↓ | Dice | ASD ↓ |
| FDK [4] | 15.34 | 35.78 | 16.51 | 79.55 | 46.14 | 22.44 |
| NeRP [31] | 23.55 | 74.46 | 86.55 | 9.57 | 86.24 | 3.62 |
| FBPConvNet [13] | 24.38 | 77.36 | 92.78 | 3.14 | 91.37 | 2.68 |
| FreeSeed [20] | 25.59 | 77.36 | 95.16 | 1.74 | 94.75 | 1.77 |
| PixelNeRF [43] | 24.66 | 78.68 | 91.00 | 5.31 | 91.66 | 3.67 |
| DIF-Net [18] | 25.55 | 84.40 | 94.45 | 2.51 | 94.78 | 2.01 |
| C²RV | 29.23 | 92.78 | 96.72 | 1.25 | 96.93 | 1.12 |

### 5. Ablation Study

Ablation studies are conducted to explore the effectiveness of the proposed MS-3DV and SVC-Att, and different designs for MS-3DV. Moreover, we further analyze the robustness of our C²RV to varying viewing angles and noisy scanning parameters. All the following ablative experiments are conducted on 6-view reconstruction of chest CT with the resolution of 256³.

### 5.1. Proposed MS-3DV and SVC-Att

Ablation on MS-3DV and SVC-Att. We regard DIFNet [18] as the baseline model and compare the reconstruction performance of introducing MS-3DV and SVC-Att. In DIF-Net, multi-view features are aggregated (σ in EQN. 2) with MLPs or Max-Pooling+MLPs. Comparison on different aggregation methods is made in Table 3. In (+MS-3DV), multi-scale voxel-aligned features are concatenated with max-pooled multi-scale features. In (+SVC), we randomly initialize a learnable vector before training, as an alternative to the reference feature (i.e. [symbol] (p) in EQN. 9); also see FIG. 4. Both MS-3DV and SVC-Att can improve the reconstruction performance, and the framework achieves new state-of-the-art performance by jointly incorporating the above two.

TABLE 3
Ablation study on different aggregation methods (M.:
MLPs [18], Max-M.: Max-Pooling + MLPs [18],
SVC: our proposed scale-view cross-attention) and MS-3DV.
PSNR (dB) and SSIM (×10⁻²) are evaluated on
6-view reconstruction of chest CT.

| | Aggregation | | | | | |
|---|---|---|---|---|---|---|
| Method | M. | Max-M. | SVC | MS-3DV | PSNR | SSIM |
| DIF-Net [18] | ✓ | | | | 25.55 | 84.42 |
| | | ✓ | | | 25.62 | 84.40 |
| +MS-3DV | | ✓ | | ✓ | 26.62 | 87.33 |
| +SVC | | | ✓ | | 27.84 | 90.22 |
| C²RV | | | ✓ | ✓ | 29.23 | 92.78 |

Different Designs for MS-3DV. Table 4 provides an ablation study on the number of scales, the initial feature map F¹, and the initial resolution r¹. The selection of F¹ can be the final-layer feature map of the encoder or decoder. PSNR and SSIM values are evaluated on 6-view reconstruction of chest CT. As shown in Table 4, we compare the performance of using different numbers of scales, and selections of initial feature map F¹ and resolution r¹. It is important to incorporate multi-scale features, which provide richer information than single-scale for identifying different anatomies, such as organs (e.g., lung) and bones (e.g., spine). We do not further increase the number of scales (e.g., 4) since the size of the feature map at the third scale is too small (i.e. 4×4). For the choice of F¹, the output of the encoder is better as it contains more high-level features than the decoder. Empirically, the initial resolution of 16 is the best choice for the trade-off between the global (high-level) and local (details) features.

TABLE 4
Ablation study on the number of scales, the initial feature
map F¹, and the initial resolution r¹. The selection of F¹ can be the
final-layer feature map of the encoder or decoder. PSNR and SSIM
are evaluated on 6-view reconstruction of chest CT.

| # Scales | F¹ | r¹ | PSNR (dB) | SSIM (10⁻²) |
|---|---|---|---|---|
| 1 | Encoder | 16 | 28.98 (−0.25) | 92.38 (−0.40) |
| 2 | Encoder | 16 | 29.09 (−0.14) | 92.57 (−0.21) |
| 3 | Decoder | 16 | 28.57 (−0.66) | 91.85 (−0.93) |
| 3 | Encoder | 12 | 28.96 (−0.27) | 92.72 (−0.06) |
| 3 | Encoder | 24 | 29.23 (−0.00) | 92.75 (−0.03) |
| 3 | Encoder | 16 | 29.23 | 92.78 |

### 5.2. Robustness Analysis

Let [symbol] ={α₁, . . . , α_{N}} denote the viewing angles in the original evaluation. The first experiment is conducted by choosing different viewing angles, i.e. [symbol] ={αᵢ+Δα|αᵢ∈ [symbol] }, where Δα is the angle offset. Table 5 lists results of robustness analysis on varying angles and noisy scanning parameters. As shown in Table 5, the performance of C²RV is stable with varying angles. The second study is about the noisy scanning parameters. Taking the viewing angles as an example, we assume the measurement process is noisy, which means that multi-view projections are measured from [symbol] ={αᵢ+ηᵢ|αᵢ∈ [symbol] }, where ηᵢ is the noise that obeys the uniform distribution U(−ϵ, +ϵ). In this case, the projection function π is still defined based on original viewing angles, i.e. [symbol] , since the noise is unobservable. In Table 5, we consider two scanning parameters, including the viewing angle, and the distance of source to origin, which are major factors related to the formulation of the projection function (see Appendix in [18]). Experiments show that our C²RV is robust to slight shifts in scanning parameters.

TABLE 5
Robustness analysis on varying angles and noisy scanning
parameters, including viewing angles and the distance of
source to origin (DSO). For noisy scanning parameters,
the noisy offsets obey the uniform distribution,
i.e. U(−ϵ, +ϵ). PSNR and SSIM are
evaluated on 6-view reconstruction of chest CT.

| Varying | Noisy Parameters | | | |
|---|---|---|---|---|
| angles | Angles | DSO | PSNR (dB) | SSIM (10⁻²) |
| 0° | — | — | 29.23 | 92.78 |
| +10° | — | — | 29.24 (+0.01) | 92.80 (+0.02) |
| +20° | — | — | 29.23 (−0.00) | 92.79 (+0.01) |
| 0° | +0.5° | — | 28.98 (−0.25) | 92.57 (−0.21) |
| | +1.0° | — | 28.18 (−1.05) | 91.88 (−0.90) |
| 0° | — | +2 mm | 29.04 (−0.19) | 92.64 (−0.14) |
| | — | +3 mm | 27.85 (−1.38) | 91.61 (−1.17) |

### 6. Embodiments of Present Disclosure

Embodiments of the present disclosure are developed as follows based on the details, examples, applications, etc. regarding the C²RV framework as disclosed above possibly with generalization.

An aspect of the present disclosure is to provide a computer-implemented method for reconstructing a 3D CT volume from a plurality of projection views generated in CBCT imaging. The method utilizes cross-region and cross-view feature learning for enhancing pixel representation in reconstructing the 3D CT volume.

Although the disclosed method is particularly advantageous for sparse-view CBCT reconstruction, the present disclosure is not limited only to sparse-view CBCT reconstruction; the disclosed method is usable for CBCT reconstruction under any number of views.

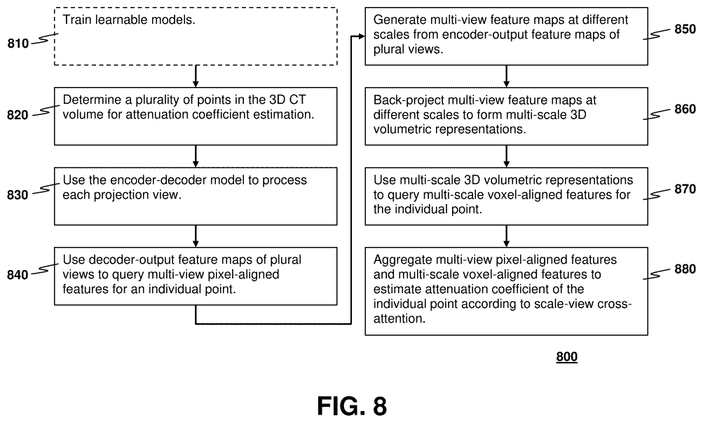

The disclosed method is exemplarily illustrated with the aid of FIGS. 3 and 8. FIG. 3 provides a conceptual diagram for illustrating the C²RV framework. FIG. 8 depicts a workflow 800 showing exemplary steps of the disclosed method. The method comprises steps 820, 830, 840, 850, 860, 870 and 880.

In the step 820, which is an initialization step, a plurality of points in the 3D CT volume is determined. The 3D CT volume is reconstructed via estimating an attenuation coefficient 390 of an individual point in the plurality of points. Those skilled in the art will be able to determine appropriate pluralities of points for attenuation-coefficient estimation according to practical situations of CBCT imaging under consideration.

In the step 830, a learnable encoder-decoder model 310, which is a machine-learning model having an encoder-decoder architecture, is used to process an individual projection view in the plurality of projection views to thereby generate a decoder-output feature map and an encoder-output feature map for the individual projection view. Particularly, the learnable encoder-decoder model is shared by the plurality of projection views in processing the individual projection view. By having the encoder-decoder architecture, the learnable encoder-decoder model 310 is formed with an encoder 311 and a decoder 312. The decoder-output feature map is a feature map obtained at an output of the decoder 312. Note that the decoder-output feature map is also a finally-obtained feature map of the learnable encoder-decoder model 310. The encoder-output feature map is a feature map obtained at an output of the encoder 311. The encoder-output feature map is an intermediate feature map, which is not the finally-obtained feature map of the learnable encoder-decoder model 310. Also note that the encoder 311 and the decoder 312 are 2D ones for processing the individual projection view, which is a 2D image. In certain embodiments, the learnable encoder-decoder model 310 is implemented as a U-Net.

After respective decoder-output feature maps generated for the plurality of projection views 305 (namely, [symbol] , . . . , [symbol] ) are obtained, plural multi-view pixel-aligned features 320 for the individual point are queried from the respective decoder-output feature maps [symbol] , . . . , [symbol] in the step 840.

The plural multi-view pixel-aligned features 320 for the individual point are obtained from the respective decoder-output feature maps generally by using the decoder-output feature map obtained for the individual projection view to query a view-specific pixel-aligned feature for the individual point under the individual projection view. Respective view-specific pixel-aligned features generated for the plurality of projection views 305 are regarded as the plural multi-view pixel-aligned features 320 for the individual point. In certain embodiments, the view-specific pixel-aligned feature for the individual point under the individual projection view is obtained by interpolating the decoder-output feature map in accordance with EQN. 1. In certain embodiments, k-linear interpolation, k being an integer greater than unity, is used for interpolating the decoder-output feature map.

In the step 850, plural multi-view feature maps 330 at different scales are generated. The different scales correspond to different resolutions of the plural multi-view feature maps 330. As such, the different scales are defined to consist of a highest resolution and one or more reduced resolutions. Among the plural multi-view feature maps 330, a first multi-view feature map generated at the highest resolution (viz., {F₁¹, . . . , F_{N}¹}) is obtained by grouping together respective encoder-output feature maps generated for the plurality of projection views 305 (viz., F₁, . . . , F_{N}). For an individual reduced resolution, a corresponding multi-view feature map generated at an individual reduced resolution (viz., {F₁ⁱ, . . . , F_{N}ⁱ}, i∈{2, . . . , N}) is obtained by down-sampling the first multi-view feature map.

In the step 860, the plural multi-view feature maps 330 at the different scales as obtained in the step 850 are back-projected to corresponding 3D spaces voxelized according to the different scales to thereby form plural multi-scale 3D volumetric representations 340, respectively. Since a scale corresponds to a resolution as mentioned above, it follows that a 3D space voxelized according to a scale means a 3D space voxelized with the corresponding resolution. EQN. 6 may be adopted in generating each of the plural multi-scale 3D volumetric representations 340.

In the step 870, plural multi-scale voxel-aligned features 350 for the individual point are queried from the plural multi-scale 3D volumetric representations 340.

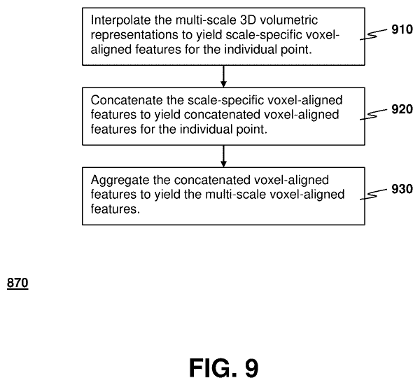

The plural multi-scale 3D volumetric representations 340 may be used to query the plural multi-scale voxel-aligned features 350 for the individual point by adopting EQN. 7. FIG. 9 depicts a flowchart for adopting EQN. 7 in implementing the step 870. The step 870 may include steps 910, 920 and 930.

In the step 910, the plural multi-scale 3D volumetric representations 340 are interpolated to yield plural scale-specific voxel-aligned features for the individual point (viz., [symbol] (p), s=1, . . . , S), respectively. In certain embodiments, k-linear interpolation, k being an integer greater than unity, is used for interpolating each of the plural multi-scale 3D volumetric representations 340.

In the step 920, the plural scale-specific voxel-aligned features are concatenated to yield concatenated voxel-aligned features for the individual point (viz., Concat[ [symbol] (p), . . . , [symbol] (p)] as shown in EQN. 7).

In the step 930, the concatenated voxel-aligned features are aggregated to yield the plural multi-scale voxel-aligned features 350 such that a channel size of the plural multi-scale voxel-aligned features 350 is consistent with a channel size of the multi-view pixel-aligned features 320. In certain embodiments of the step 930, MLPs are used to map the channel size of the plural multi-scale voxel-aligned features 350 to be consistent with the channel size of the multi-view pixel-aligned features 320.

Refer to FIG. 8. In the step 880, the plural multi-view pixel-aligned features 320 and the plural multi-scale voxel-aligned features 350 are aggregated to estimate the attenuation coefficient 390 of the individual point. In particular, the aggregation is performed according to scale-view cross-attention 360 for advantageously leveraging cross-region and cross-view feature learning to enhance representation of the individual point before the attenuation coefficient 390 is estimated.

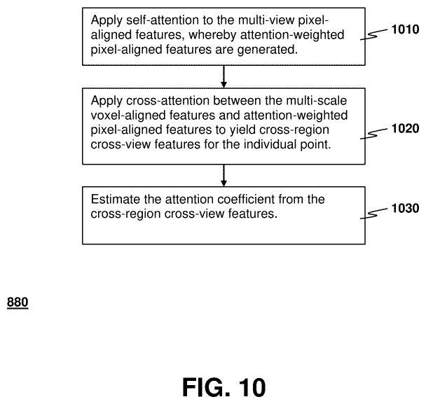

The scale-view cross-attention 360 may be realized by adopting EQN. 9. FIG. 10 depicts a flowchart showing exemplary steps for implementing the step 880 by adopting EQN. 9. In certain embodiments, the step 880 includes steps 1010, 1020 and 1030. In the step 1010, a self-attention is applied to the plural multi-view pixel-aligned features 320 for conducting cross-view attention across the plural multi-view pixel-aligned features 320, whereby plural attention-weighted pixel-aligned features (viz., [symbol] (p)) are generated. In the step 1020, a cross-attention is applied between the plural multi-scale voxel-aligned features and the plural attention-weighted pixel-aligned features to thereby yield plural cross-region cross-view features for the individual point (viz., [symbol] (p)). In the step 1030, the attenuation coefficient 390 is estimated from the plural cross-region cross-view features by using, for instance, a linear layer 430 to process the plural cross-region cross-view features.

The step 880 may be executed by the learnable aggregation-and-estimation model 400, which is depicted in FIG. 4. In certain embodiments, the disclosed method further comprises using the learnable aggregation-and-estimation model 400 to aggregate the plural multi-view pixel-aligned features 320 and the plural multi-scale voxel-aligned features 350 to estimate the attenuation coefficient 390. The learnable aggregation-and-estimation model 400 comprises a plurality of SVC-Att modules 410 stacked together for applying the self-attention to the plural multi-view pixel-aligned features 320 and applying the cross-attention between the plural multi-scale voxel-aligned features 350 and the plural attention-weighted pixel-aligned features. The plurality of SVC-Att modules 410 outputs the plural cross-region cross-view features for the individual point. The learnable aggregation-and-estimation model 400 further comprises a linear layer 430 following the plurality of SVC-Att modules 410. The linear layer 430 is used for estimating the attenuation coefficient 390 from the cross-region cross-view features.

Note that the learnable encoder-decoder model 310 and the learnable aggregation-and-estimation model 400 are required to be trained before the steps 830 and 880 are executed, respectively. In one option, each of these learnable models 310, 400 is a pre-trained model loaded with predetermined model parameters. In another option, the disclosed method further comprises a training step 810. The step 810 may include training the learnable encoder-decoder model before using the learnable encoder-decoder model in the step 830. The step 810 may also include training the learnable aggregation-and-estimation model 400 before using the learnable encoder-decoder model in the step 880.

The present disclosure may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### REFERENCES

There follows a list of references that are occasionally cited in the specification. Each of the disclosures of these references is incorporated by reference herein in its entirety.
[1] Anders H Andersen and Avinash C Kak. Simultaneous algebraic reconstruction technique (sart): a superior implementation of the art algorithm. Ultrasonic imaging, 6(1): 81-94, 1984.
[2] Hyungjin Chung, Dohoon Ryu, Michael T McCann, Marc L Klasky, and Jong Chul Ye. Solving 3d inverse problems using pre-trained 2d diffusion models. In Proceedings of the IEEE/CVF Conference on Computer Vision and Pattern Recognition, pages 22542-22551, 2023.
[3] Yu Fang, Lanzhuju Mei, Changjian Li, Yuan Liu, Wenping Wang, Zhiming Cui, and Dinggang Shen. Snaf: Sparseview cbct reconstruction with neural attenuation fields. arXiv preprint arXiv: 2211.17048, 2022.
[4] Lee A Feldkamp, Lloyd C Davis, and James W Kress. Practical cone-beam algorithm. Josa a, 1(6): 612-619, 1984.
[5] Richard Gordon, Robert Bender, and Gabor T Herman. Algebraic reconstruction techniques (art) for three-dimensional electron microscopy and x-ray photography. Journal of theoretical Biology, 29(3): 471-481, 1970.
[6] Yo Seob Han, Jaejun Yoo, and Jong Chul Ye. Deep residual learning for compressed sensing ct reconstruction via persistent homology analysis. arXiv preprint arXiv:1611.06391, 2016.
[7] Ji He, Yongbo Wang, and Jianhua Ma. Radon inversion via deep learning. IEEE transactions on medical imaging, 39 (6):2076-2087, 2020.
[8] Johannes Hofmanninger, Forian Prayer, Jeanny Pan, Sebastian Rohrich, Helmut Prosch, and Georg Langs. Automatic lung segmentation in routine imaging is primarily a data diversity problem, not a methodology problem. European Radiology Experimental, 4(1): 1-13, 2020.
[9] Gao Huang, Zhuang Liu, Laurens Van Der Maaten, and Kilian Q Weinberger. Densely connected convolutional networks. In Proceedings of the IEEE Conference on Computer Vision and Pattern Recognition, pages 4700-4708, 2017.
[10] Xia Huang, JianWang, Fan Tang, Tao Zhong, and Yu Zhang. Metal artifact reduction on cervical ct images by deep residual learning. Biomedical engineering online, 17: 1-15, 2018.
[11] Zeng Huang, Yuanlu Xu, Christoph Lassner, Hao Li, and Tony Tung. Arch: Animatable reconstruction of clothed humans. In Proceedings of the IEEE/CVF Conference on Computer Vision and Pattern Recognition, pages 3093-3102, 2020.
[12] Yixiang Jiang. Mfct-gan: multi-information network to reconstruct ct volumes for security screening. Journal of Intelligent Manufacturing and Special Equipment, 2022.
[13] Kyong Hwan Jin, Michael T McCann, Emmanuel Froustey, and Michael Unser. Deep convolutional neural network for inverse problems in imaging. IEEE Transactions on Image Processing, 26(9):4509-4522, 2017.
[14] Daeun Kyung, Kyungmin Jo, Jaegul Choo, Joonseok Lee, and Edward Choi. Perspective projection-based 3d ct reconstruction from biplanar x-rays. In ICASSP 2023-2023 IEEE International Conference on Acoustics, Speech and Signal Processing (ICASSP), pages 1-5. IEEE, 2023.
[15] Anish Lahiri, Marc Klasky, Jeffrey A Fessler, and Saiprasad Ravishankar. Sparse-view cone beam ct reconstruction using data-consistent supervised and adversarial learning from scarce training data. arXiv preprint arXiv:2201.09318, 2022.
[16] Bo Li, Kaitao Xue, Bin Liu, and Yu-Kun Lai. Bbdm: Imageto-image translation with brownian bridge diffusion models. In Proceedings of the IEEE/CVF Conference on Computer Vision and Pattern Recognition, pages 1952-1961, 2023.
[17] Wei-An Lin, Haofu Liao, Cheng Peng, Xiaohang Sun, Jingdan Zhang, Jiebo Luo, Rama Chellappa, and Shaohua Kevin Zhou. Dudonet: Dual domain network for ct metal artifact reduction. In Proceedings of the IEEE/CVF Conference on Computer Vision and Pattern Recognition, pages 10512-10521, 2019.
[18] Yiqun Lin, Zhongjin Luo, Wei Zhao, and Xiaomeng Li. Learning deep intensity field for extremely sparse-view cbct reconstruction. In Medical Image Computing and Computer Assisted Intervention—MICCAI 2023, pages 13-23, Cham, 2023. Springer Nature Switzerland.
[19] Matthew Loper, Naureen Mahmood, Javier Romero, Gerard Pons-Moll, and Michael J Black. Smpl: A skinned multiperson linear model. ACM Transactions on Graphics, 34(6), 2015.
[20] Chenglong Ma, Zilong Li, Junping Zhang, Yi Zhang, and Hongming Shan. Freeseed: Frequency-band-aware and selfguided network for sparse-view ct reconstruction. In International Conference on Medical Image Computing and Computer-Assisted Intervention, pages 250-259. Springer, 2023.
[21] Ben Mildenhall, Pratul P Srinivasan, Matthew Tancik, Jonathan T Barron, Ravi Ramamoorthi, and Ren Ng. Nerf: Representing scenes as neural radiance fields for view synthesis. Communications of the ACM, 65(1): 99-106, 2021.
[22] Jinxiao Pan, Tie Zhou, Yan Han, and Ming Jiang. Variable weighted ordered subset image reconstruction algorithm. International Journal of Biomedical Imaging, 2006, 2006.
[23] Jeong Joon Park, Peter Florence, Julian Straub, Richard Newcombe, and Steven Lovegrove. Deepsdf: Learning continuous signed distance functions for shape representation. In Proceedings of the IEEE/CVF conference on computer vision and pattern recognition, pages 165-174, 2019.
[24] Georgios Pavlakos, Vasileios Choutas, Nima Ghorbani, Timo Bolkart, Ahmed A A Osman, Dimitrios Tzionas, and Michael J Black. Expressive body capture: 3d hands, face, and body from a single image. In Proceedings of the IEEE/CVF conference on computer vision and pattern recognition, pages 10975-10985, 2019.
[25] Olaf Ronneberger, Philipp Fischer, and Thomas Brox. Unet: Convolutional networks for biomedical image segmentation. In Medical Image Computing and Computer-Assisted Intervention—MICCAI 2015: 18th International Conference, Munich, Germany, Oct. 5-9, 2015, Proceedings, Part III 18, pages 234-241. Springer, 2015.
[26] Darius Rückert, Yuanhao Wang, Rui Li, Ramzi Idoughi, and Wolfgang Heidrich. Neat: Neural adaptive tomography. ACM Transactions on Graphics (TOG), 41(4): 1-13, 2022.
[27] Shunsuke Saito, Zeng Huang, Ryota Natsume, Shigeo Morishima, Angjoo Kanazawa, and Hao Li. Pifu: Pixel-aligned implicit function for high-resolution clothed human digitization. In Proceedings of the IEEE/CVF international conference on computer vision, pages 2304-2314, 2019.
[28] William C Scarfe, Allan G Farman, Predag Sukovic, et al. Clinical applications of cone-beam computed tomography in dental practice. Journal-Canadian Dental Association, 72 (1):75, 2006.
[29] Arnaud Arindra Adiyoso Setio, Alberto Traverso, Thomas De Bel, Moira S N Berens, Cas Van Den Bogaard, Piergiorgio Cerello, Hao Chen, Qi Dou, Maria Evelina Fantacci, Bram Geurts, et al. Validation, comparison, and combination of algorithms for automatic detection of pulmonary nodules in computed tomography images: the lunal6 challenge. Medical image analysis, 42:1-13, 2017.
[30] Liyue Shen, Wei Zhao, and Lei Xing. Patient-specific reconstruction of volumetric computed tomography images from a single projection view via deep learning. Nature biomedical engineering, 3(11): 880-888, 2019.
[31] Liyue Shen, John Pauly, and Lei Xing. Nerp: implicit neural representation learning with prior embedding for sparsely sampled image reconstruction. IEEE Transactions on Neural Networks and Learning Systems, 2022.
[32] Yang Song, Liyue Shen, Lei Xing, and Stefano Ermon. Solving inverse problems in medical imaging with score-based generative models. arXiv preprint arXiv:2111.08005, 2021.
[33] Ashish Vaswani, Noam Shazeer, Niki Parmar, Jakob Uszkoreit, Llion Jones, Aidan N Gomez, tukasz Kaiser, and Illia Polosukhin. Attention is all you need. Advances in neural information processing systems, 30, 2017.
[34] Ce Wang, Kun Shang, Haimiao Zhang, Qian Li, Yuan Hui, and S Kevin Zhou. Dudotrans: dual-domain transformer provides more attention for sinogram restoration in sparse-view ct reconstruction. arXiv preprint arXiv:2111.10790, 2021.
[35] Jianing Wang, Yiyuan Zhao, Jack H Noble, and Benoit M Dawant. Conditional generative adversarial networks for metal artifact reduction in ct images of the ear. In Medical Image Computing and Computer Assisted Intervention—MICCAI 2018: 21st International Conference, Granada, Spain, Sep. 16-20, 2018, Proceedings, Part I, pages 3-11. Springer, 2018.
[36] Zhou Wang, Alan C Bovik, Hamid R Sheikh, and Eero P Simoncelli. Image quality assessment: from error visibility to structural similarity. IEEE Transactions on Image Processing, 13(4): 600-612, 2004.
[37] Weiwen Wu, Dianlin Hu, Chuang Niu, Hengyong Yu, Varut Vardhanabhuti, and GeWang. Drone: Dual-domain residual-based optimization network for sparse-view ct reconstruction. IEEE Transactions on Medical Imaging, 40(11):3002-3014, 2021.
[38] Yuliang Xiu, Jinlong Yang, Dimitrios Tzionas, and Michael J Black. Icon: Implicit clothed humans obtained from normals. In 2022 IEEE/CVF Conference on Computer Vision and Pattern Recognition (CVPR), pages 13286-13296. IEEE, 2022.
[39] Yuliang Xiu, Jinlong Yang, Xu Cao, Dimitrios Tzionas, and Michael J Black. Econ: Explicit clothed humans optimized via normal integration. In Proceedings of the IEEE/CVF Conference on Computer Vision and Pattern Recognition, pages 512-523, 2023.
[40] Qiangeng Xu, Zexiang Xu, Julien Philip, Sai Bi, Zhixin Shu, Kalyan Sunkavalli, and Ulrich Neumann. Point-nerf: Point-based neural radiance fields. In Proceedings of the IEEE/CVF Conference on Computer Vision and Pattern Recognition, pages 5438-5448, 2022.
[41] Fukun Yin, Wen Liu, Zilong Huang, Pei Cheng, Tao Chen, and Gang Yu. Coordinates are not lonely-codebook prior helps implicit neural 3d representations. Advances in Neural Information Processing Systems, 35:12705-12717, 2022.
[42] Xingde Ying, Heng Guo, Kai Ma, Jian Wu, Zhengxin Weng, and Yefeng Zheng. X2ct-gan: reconstructing ct from biplanar x-rays with generative adversarial networks. In Proceedings of the IEEE/CVF conference on computer vision and pattern recognition, pages 10619-10628, 2019.
[43] Alex Yu, Vickie Ye, Matthew Tancik, and Angjoo Kanazawa. pixelnerf: Neural radiance fields from one or few images. In Proceedings of the IEEE/CVF Conference on Computer Vision and Pattern Recognition, pages 4578-4587, 2021.
[44] Ruyi Zha, Yanhao Zhang, and Hongdong Li. Naf: Neural attenuation fields for sparse-view cbct reconstruction. In Medical Image Computing and Computer Assisted Intervention—MICCAI 2022: 25th International Conference, Singapore, Sep. 18-22, 2022, Proceedings, Part VI, pages 442-452. Springer, 2022.
[45] Zhicheng Zhang, Xiaokun Liang, Xu Dong, Yaoqin Xie, and Guohua Cao. A sparse-view ct reconstruction method based on combination of densenet and deconvolution. IEEE transactions on medical imaging, 37(6): 1407-1417, 2018.
[46] Zerong Zheng, Tao Yu, Yebin Liu, and Qionghai Dai. Pamir: Parametric model-conditioned implicit representation for image-based human reconstruction. IEEE transactions on pattern analysis and machine intelligence, 44(6): 3170-3184, 2021.

What is claimed is:

1. A computer-implemented method for reconstructing a three-dimensional (3D) computed tomography (CT) volume from a plurality of projection views generated in cone-beam computed tomography (CBCT) imaging, the method comprising:
determining a plurality of points in the 3D CT volume such that the 3D CT volume is reconstructed via estimating an attenuation coefficient of an individual point;
using a learnable encoder-decoder model to process an individual projection view to thereby generate a decoder-output feature map and an encoder-output feature map for the individual projection view, wherein the learnable encoder-decoder model is shared by the plurality of projection views in processing the individual projection view;
using respective decoder-output feature maps generated for the plurality of projection views to query plural multi-view pixel-aligned features for the individual point;
generating plural multi-view feature maps at different scales, the different scales consisting of a highest resolution and one or more reduced resolutions, wherein a first multi-view feature map generated at the highest resolution is obtained by grouping together respective encoder-output feature maps generated for the plurality of projection views, and wherein a corresponding multi-view feature map generated at an individual reduced resolution is obtained by down-sampling the first multi-view feature map;
back-projecting the plural multi-view feature maps at the different scales to corresponding 3D spaces voxelized according to the different scales to thereby form plural multi-scale 3D volumetric representations, respectively;
using the plural multi-scale 3D volumetric representations to query plural multi-scale voxel-aligned features for the individual point; and
aggregating the plural multi-view pixel-aligned features and the plural multi-scale voxel-aligned features to estimate the attenuation coefficient of the individual point according to scale-view cross-attention for leveraging cross-region and cross-view feature learning to enhance representation of the individual point before the attenuation coefficient is estimated.

2. The method of claim 1, wherein the plural multi-view pixel-aligned features for the individual point are obtained from the respective decoder-output feature maps by using the decoder-output feature map to query a view-specific pixel-aligned feature for the individual point under the individual projection view, whereby respective view-specific pixel-aligned features generated for the plurality of projection views are regarded as the plural multi-view pixel-aligned features for the individual point.

3. The method of claim 2, wherein the view-specific pixel-aligned feature for the individual point under the individual projection view is obtained by interpolating the decoder-output feature map.

4. The method of claim 3, wherein k-linear interpolation, k an integer greater than unity, is used for interpolating the decoder-output feature map.

5. The method of claim 1, wherein the using of the plural multi-scale 3D volumetric representations to query the plural multi-scale voxel-aligned features for the individual point includes:
interpolating the plural multi-scale 3D volumetric representations to yield plural scale-specific voxel-aligned features for the individual point, respectively;
concatenating the plural scale-specific voxel-aligned features to yield concatenated voxel-aligned features for the individual point; and
aggregating the concatenated voxel-aligned features to yield the plural multi-scale voxel-aligned features such that a channel size of the plural multi-scale voxel-aligned features is consistent with a channel size of the multi-view pixel-aligned features.

6. The method of claim 5, wherein k-linear interpolation, k an integer greater than unity, is used for interpolating each of the plural multi-scale 3D volumetric representations.

7. The method of claim 5, wherein in aggregating the concatenated voxel-aligned features to yield the plural multi-scale voxel-aligned features, multilayer perceptrons (MLPs) are used to map the channel size of the plural multi-scale voxel-aligned features to be consistent with the channel size of the multi-view pixel-aligned features.

8. The method of claim 1, wherein the aggregating of the plural multi-view pixel-aligned features and the plural multi-scale voxel-aligned features to yield the attenuation coefficient of the individual point according to scale-view cross-attention includes:
applying a self-attention to the plural multi-view pixel-aligned features for conducting cross-view attention across the plural multi-view pixel-aligned features, whereby plural attention-weighted pixel-aligned features are generated;
applying a cross-attention between the plural multi-scale voxel-aligned features and the plural attention-weighted pixel-aligned features to thereby yield plural cross-region cross-view features for the individual point; and
estimating the attenuation coefficient from the cross-region cross-view features.

9. The method of claim 8, wherein the attenuation coefficient is estimated from the cross-region cross-view features by using a linear layer to process the cross-region cross-view features.

10. The method of claim 8 further comprising using a learnable aggregation-and-estimation model to aggregate the plural multi-view pixel-aligned features and the plural multi-scale voxel-aligned features to estimate the attenuation coefficient, wherein the learnable aggregation-and-estimation model comprises:
a plurality of scale-view cross attention (SVC-Att) modules stacked together for applying the self-attention to the plural multi-view pixel-aligned features and applying the cross-attention between the plural multi-scale voxel-aligned features and the plural attention-weighted pixel-aligned features, wherein the plurality of SVC-Att modules outputs the plural cross-region cross-view features for the individual point; and
a linear layer following the plurality of SVC-Att modules for estimating the attenuation coefficient from the cross-region cross-view features.

11. The method of claim 1, wherein the learnable encoder-decoder model is implemented as a U-Net.

12. The method of claim 1 further comprising training the learnable encoder-decoder model before using the learnable encoder-decoder model to process the individual projection view.

13. The method of claim 10 further comprising training the learnable aggregation-and-estimation model before aggregating the plural multi-view pixel-aligned features and the plural multi-scale voxel-aligned features to estimate the attenuation coefficient according to scale-view cross-attention.
